(19) United States
(12) Patent Application Publication
(10) Pub. No.: US 2026/0290104 A1
(43) Pub. Date: Sep. 24, 2026

(54) SYSTEMS AND METHODS FOR GESTURE-DRIVEN GROUP CONSENSUS ACROSS DINING, ENTERTAINMENT, AND OTHER EXPERIENCES

(71) Applicant: Lauren Malhoit, Indianapolis, IN (US)

(72) Inventor: Lauren Malhoit, Indianapolis, IN (US)

(21) Appl. No.: 19/347,082

(22) Filed: Oct. 1, 2025

Related U.S. Application Data
(60) Provisional application No. 63/774,429, filed on Mar. 19, 2025.

(51) Int. Cl. G07C 13/00; G06F 3/04883; G06F 3/16; G06Q 10/02; G06Q 30/0282; G06Q 30/0601

(52) U.S. Cl. CPC G07C 13/00; G06F 3/04883; G06F 3/167; G06Q 10/02; G06Q 30/0282; G06Q 30/0631

(57) ABSTRACT

A computer-implemented system and method for consensus-based group decision-making are disclosed. Multiple users interact with candidate options—such as restaurants, cafes, entertainment venues, travel accommodations, media, or workplace feature sets—via gesture-based or equivalent selection inputs. User preferences and interactions are aggregated in real time by a consensus algorithm that applies weighted values to approval, disapproval, and indifference inputs to identify selections meeting a threshold. The system outputs one or more consensus choices and, in response to selection, automatically initiates post-selection functions including generating reservations or bookings, presenting rating or review interfaces, or sharing results with the group. The invention reduces decision fatigue and enables timely, equitable outcomes across diverse domains requiring group consensus.

### CROSS-REFERENCE TO RELATED APPLICATIONS

This application claims the benefit of Provisional Application No. 63/774,429, filed Mar. 19, 2025, the contents of which are herein incorporated by reference.

### BACKGROUND OF THE INVENTION

### Field of Endeavor

The present invention relates to recommendation and consensus systems, and more particularly, to systems and methods for group decision-making across domains such as dining, entertainment, travel, media, and workplace collaboration.

### Background of Related Art

People frequently experience frustration and indecision when making group choices. Whether selecting a restaurant, deciding on a concert or movie, curating a shared music playlist, choosing a travel accommodation, or prioritizing product features in a workplace setting, groups often face wasted time, uneven influence, dissatisfaction, or repetitive outcomes.

Existing discovery and recommendation platforms exacerbate these problems. For example, restaurant platforms typically overwhelm users with static lists and outdated reviews, which do not help groups converge on a choice. Media or entertainment platforms often require each participant to explicitly select or vote, which can bias results or slow consensus. Workplace collaboration tools generally lack intuitive mechanisms for aggregating independent inputs into a fair group decision.

Simultaneously, providers of services or venues, such as small restaurants, local event organizers, or independent product teams, struggle with visibility when groups fail to discover or agree upon them. This disconnect prevents users from finding optimal choices and limits growth for deserving businesses and creators.

As can be seen, there is a need for a system and method that improves existing platforms by enabling multiple users to independently express preferences through an intuitive interface (e.g., swipe or gesture-based), with results aggregated by a consensus algorithm. Such a system reduces decision fatigue, ensures more relevant and fair recommendations, and makes group choices faster, more collaborative, and more accurate across multiple domains.

### SUMMARY

The present disclosure relates to systems and methods for facilitating group decision-making through real-time, consensus-based interaction. In typical group decisions, e.g., selecting a venue, media item, travel accommodation, or prioritizing product features, indecision and uneven influence impede timely outcomes. The disclosed systems enable independent evaluation followed by structured aggregation to generate consensus selections.

In some embodiments, a server-managed group session defines a common candidate set referenced by compact identifiers. Client devices transmit interaction signals (e.g., approve/disapprove/indifferent) tagged with session and candidate identifiers. The server can aggregate the signals in real time and, in certain implementations, update the common candidate set without pushing full metadata to each device, outputting consensus selections once a quorum or weighted threshold is met.

The invention is not limited to dining or entertainment contexts. It applies broadly to any domain requiring group consensus, including but not limited to:
Hospitality and dining: restaurants, bars, cafes.
Experiences: concerts, comedy shows, art exhibits, or local events.
Media: movie selection, group-curated music playlists.
Travel and accommodations: selecting Airbnb or hotel options.
Workplace collaboration: prioritizing features, tasks, or strategic initiatives in product or project development.

By aggregating independent user interactions into a server-side consensus pipeline that operates on identifier-addressed candidate sets, the system minimizes redundant transmissions, reduces client-side compute, and generates timely, machine-processable outputs applicable across multiple domains.

These and other features will be more fully understood from the following detailed description and accompanying drawings.

### BRIEF DESCRIPTION OF THE DRAWINGS

FIG. 1 is a block diagram of the ForkYes Environment 100, according to aspects of the present disclosure.

FIG. 2 is a flow diagram of a method 200 for consensus-based selection of candidate options using swipe-based interactions, according to aspects of the present disclosure.

### DETAILED DESCRIPTION OF THE DISCLOSURE

The following detailed description sets forth exemplary embodiments of the invention. While particular examples reference restaurant and dining discovery, the inventive concepts described herein are not limited to that domain. Instead, the system and method provide a general framework for group consensus decision-making in contexts where multiple individuals must select from a pool of candidate options. In embodiments, each group session is represented by a session record stored in database 114 including: a session identifier, a list of candidate identifiers, a per-user interaction log keyed by (user id, candidate id, interaction type, timestamp), and a consensus state vector storing per-candidate aggregate scores and thresholds.

In various embodiments, the invention enables each participant to independently express preferences using an intuitive gesture-based or swipe-based interface. These inputs are then aggregated in real time by a consensus algorithm that applies weighted scoring or other decision rules to identify one or more options that best satisfy the group. This approach encourages independent thinking while facilitating efficient group consensus, a process that research has shown to often yield superior outcomes compared to decisions made by a single individual.

Although restaurant and bar selection serve as illustrative examples, the same framework can be applied to diverse domains such as:
selecting a movie, playlist, or entertainment activity,
choosing among potential travel destinations, accommodations, or experiences (e.g., concerts, comedy shows, art exhibitions),
facilitating workplace decision-making, including prioritizing product features or project initiatives, and
any scenario in which rapid, fair, and user-friendly consensus among multiple participants is beneficial.

The following sections describe in greater detail particular implementations, including a restaurant discovery embodiment, while recognizing that these examples are merely illustrative and do not limit the broader scope of the invention.

Existing restaurant discovery platforms have several disadvantages that contribute to these challenges. They often rely on outdated reviews and inconsistent recommendations, which can lead to decision-making difficulties, especially for groups. These platforms typically present users with overwhelming lists of options without providing a real-time, accurate, and intuitive way for multiple people to agree on a restaurant. This lack of a seamless decision-making process often results in frustration and indecision, leaving users dissatisfied with their dining experiences. Existing discovery platforms typically require users to explicitly select venues or detailed characteristics upfront. By contrast, the disclosed system dynamically surfaces options via an intuitive swipe-based interface and aggregates real-time interactions to identify group matches without requiring explicit pre-selection. This interaction reduces cognitive load, enables independent inputs, and streamlines group decision-making.

The present invention addresses these issues by introducing a novel swipe-based group decision-making system designed to enhance the restaurant discovery and selection process. This system, hereinafter ForkYes, enables groups to seamlessly match restaurants based on their individual preferences through an intuitive swipe-based system. By eliminating decision fatigue and ensuring more relevant recommendations, ForkYes makes dining decisions faster and more collaborative. The system intelligently aggregates individual user preferences within a group, suggesting optimal restaurant matches and facilitating a consensus-driven decision-making process from independent thinking and buy-in of all group members. This innovative approach not only improves the user experience but also enhances representation of candidate options that would otherwise be excluded, ensuring they reach the right audience at the right time.

Broadly, the present invention can be implemented as a system having one or more computing systems executing one or more modules, software, applications, etc. In embodiments, the system of the present invention can include a plurality of components, or modules, configured to create an intuitive, group-friendly restaurant discovery experience. Unlike other recommendation systems that aggregate preference data in batch processes, the present invention uses real-time user interactions (swipe-based inputs) to immediately update recommendation probabilities, enabling instant group consensus and significantly reducing decision time.

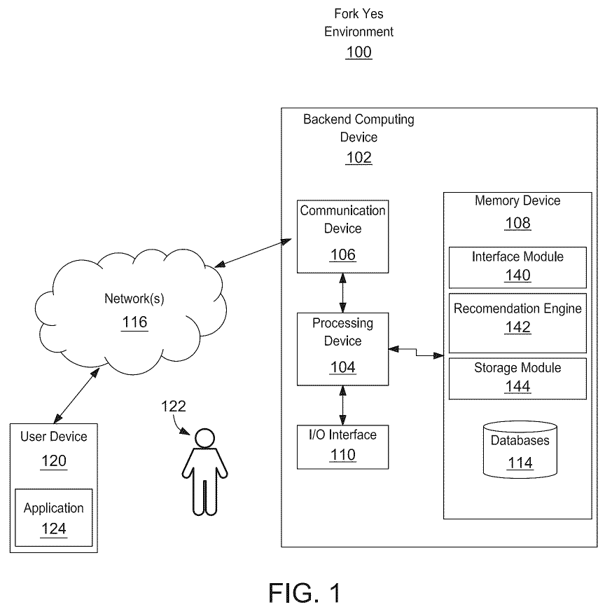

Referring now to FIG. 1, FIG. 1 illustrates a block diagram of the ForkYes Environment 100, according to aspects of the present disclosure. While FIG. 1 illustrates various components of the ForkYes Environment 100, additional components can be added, and existing components can be removed.

As illustrated in FIG. 1, the Backend Computing System 102 includes one or more processing devices, herein processing device 104, coupled to a communication device 106. The processing device 104 is also coupled to a memory device 108, and an input/output (“I/O”) interface 110. In embodiments, the communication device 106 enables the Backend Computing System 102 to communicate with other devices and systems via one or more networks 116. The Backend Computing System 102 can communicate with a user device 120 via the network 116. A user 122 can utilize the user device 120 to communicate with the Backend Computing System 102. The user device 120 can include one or more electronic devices such as a laptop computer, a desktop computer, a tablet computer, a smartphone, a thin client, a smart appliance, and the like. While FIG. 1 illustrates one user device 120, the ForkYes Environment 100 can include multiple user devices operated by the user 122 or operated by other users.

The essential elements of the one or more electronic devices are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. Processors suitable for the execution of a computer program include, by way of example, both general and special purpose microprocessors, and any one or more processors of any kind of digital computer. Generally, a processor will receive instructions and data from a read only memory or a random access memory or both.

According to the aspects of the present disclosure, the Backend Computing System 102 enables the user 122, operating a copy of an application 124 executing on the user device 120, to communicate with the Backend Computing System 102 and leverage the service provided by the Backend Computing System 102. The Backend Computing System 102 is configured to receive data from the user 122, via application 124 of user device 120, process the data and return one or more recommendations to user 122 for further selection, or interaction, which is provided to Backend Computing System 102. In response to the further interaction, Backend Computing System 102 is configured to perform one or more additional functions related to the selection, or interaction.

To perform the process described herein, the Backend Computing System 102 can store and execute an Interface module 140, a Recommendation Engine 142, and a Storage module 144 to perform the processes and methods described herein. The Interface module 140, the Recommendation Engine 142, and the Storage module 144 can be stored in the memory device 108. The Interface module 140, the Recommendation Engine 142, and the Storage module 144 can include the necessary logic, instructions, and/or programming to perform the processes and methods described in further detail below. The Interface module 140, the Recommendation Engine 142, and the Storage module 144 can be written in any programming language.

In embodiments, the application 124 can be a specifically designed application that operates with the Backend Computing System 102 to perform the processes and methods described herein. In embodiments, the application 124 can be a third-party application, such as a web browser, that communicates with the Backend Computing System 102 to perform the processes and methods described herein.

In embodiments, the application 124 includes a number of modules, components, processes, User Interface(s), User Experience(s), etc., configured to receive data inputs from the user 122, for processing by the Backend Computing System 102. In embodiments, a User Profile Module is included in the number of modules and is configured to receive one or more user profile data items from the user 122, using the user device 120. The one or more user profile data items include, but are not limited to, a name, a unique identifier, one or more demographic information items of the user, one or more user preferences, one or more past interactions, one or more connections, such as connections with additional users, and/or a dining history of the user. In embodiments, the one or more past interactions includes, but are not limited to, one or more restaurant reviews provided by the user. In embodiments, the one or more user profile data items are transmitted to Backend Computing System 102, processed by Interface Module 140, and stored to the one or more database(s) 114 using Storage Module 144.

A User Selection Module is included in the number of modules and is configured to allow the user 122 to interact with one or more recommendations provided by the Backend Computing System 102. In embodiments, the User Selection Module includes a User Interface Component configured to accept one or more inputs from the user 122 through one or more user interface elements, and additional functionality to map the one or more inputs from the user to one or more responses. In embodiments, the one or more inputs is one or more of a left swipe on one or more of the user interface elements, a right swipe on the one or more user interface elements, one or more multi-modal inputs, one or more voice commands, one or more inputs from an I/O device, and/or one or more tactile interactions with the one or more user interface elements. In embodiments, mapping the one or more inputs includes logic, or functionality, to map a first input, such as a left-swipe, to a negative feedback response, and/or to map a second input, such as a right-swipe, to a positive feedback responses. In embodiments, the User Selection Module includes functionality to provide the one or more mapped inputs, as one or more responses, to the Recommendation Engine 142 in real-time, such that the inputs are used to refine recommendations by the Backend Computing System 102.

A Location-Based Filtering Module is included in the number of modules and is configured to report a location of the user device 120 to the Backend Computing System 102. In embodiments, the Location-Based Filtering Module retrieves a location of the user device 120 using a Global Positioning System (GPS) module coupled thereto, and transmits the location to Backend Computing System 102. In embodiments, Backend Computing System 102 utilizes the location of the user device 120 to filter recommendations provided by the Recommendation Engine 142, ensuring recommendations are personalized to the user's 122 location.

A Feedback and Personalization module is included in the number of modules and is configured to provide one or more user interfaces, and functions, to collect one or more restaurant ratings from the user 122, and/or one or more reviews after visits from the user 122. In embodiments, Feedback and Personalization module collects the ratings and reviews and transmits them to the Backend Computing System 102 for further processing. In embodiments, the ratings and reviews are provided to the Recommendation Engine 102, and/or one or more Machine Learning Models configured to refine recommendations over time.

One or more Integration module and/or Convenience modules, and/or Notifications modules are included in the number of modules. In embodiments, the one or more Integration modules, or Convenience modules are configured to provide one or more user interfaces, and functions, to create/update/modify/delete one or more dining reservations. In embodiments, one or more dining reservations can be automatically initiated, using the Integration module, which includes one or more API to connect to reservation systems. In embodiments, the user 122 provides one or more reservation data items to the Integration module, which connects to an appropriate reservation system to complete a dining reservation. Additionally, the one or more Integration modules, or Convenience modules are configured to integrate social media/social sharing functionalities, such as allowing the user 122 to invite other users to join their dining group, and/or see one or more user matches. In embodiments, the Notifications modules are configured to notify the user 122 about recommendations, dining decisions, upcoming reservations, and/or any outputs of the Backend Computing system 102.

Additionally, the application 124 includes one or more User Interfaces and/or User Experience components, such as, but not limited to: a Home Screen with Personalized Suggestions configured to display the best restaurant matches for users based on past swipes and preferences; an Interactive Map View configured to offer a visual representation of nearby restaurants, complementing the swipe interface; a Filter & Search Options configured to give users more control over their selections, refining choices based on cuisine, price, and dietary restrictions; an Onboarding Tutorial configured to ensure that new users understand how the swiping and group-matching system works.

According to aspects of the present disclosure, the Backend Computing System 102, for example, via the Interface module 140, provides unique interfaces that allow the user 122 through application 124 to provide data to the Backend Computing System 102. The Backend Computing System 102, for example, via the Interface module 140, also provides one or more application programming interface (APIs) that provide connection points for one or more application, e.g., the application 124. Additionally, the Interface module 140 can operate to generate and provide graphical user interfaces (GUIs) to the application 124, for example, menus, widgets, text, images, fields, etc., as described below in further detail. The GUIs generated by the Interface module 140 can be interactive.

In embodiments, the Interface module 140 can implement voice control aspects into the interfaces provided. For example, the user can navigate the interfaces of the Backend Computing System 102 using the audio input device of the user device 120. The interface module 140 can implement one or more chat-bots to deliver conversational input and output to a user.

In an exemplary embodiment, the Interface module 140 is configured to receive data from the application 124 as an API, process the received data, and distribute the data to one or more components of the Backend Computing System 102, such as Recommendation Engine 142, Storage module 144, etc.

According to aspects of the present disclosure, the Backend Computing System 102, for example, via the Recommendation Engine 142, provides unique functionalities that allow the user 122 through application 124 to provide data to the Backend Computing System 102 which is then utilized to provide one or more recommendations to the user 122 through application 124.

In embodiments, the Recommendation Engine 142 includes a plurality of functions, sub-modules, processes, etc., configured to perform one or more aspects of restaurant recommendation. In embodiments, the plurality of functions includes, but is not limited to a recommendation engine sub-module, and/or a group matching and decision making sub-module.

In embodiments, the recommendation engine sub-module is configured to receive one or more inputs and provide one or more restaurant recommendations based on the one or more inputs.

In embodiments, the group matching and decision-making sub-module is configured to aggregate one or more interactions, and/or attributes, of the user 122, such as swipes, preferences, generated in response to the one or more restaurant recommendations, and to determine one or more consensus selections based on the one or more interactions. Additionally, the group matching and decision-making sub-module is configured to provide the one or more consensus selections to the user, such as through application 124, allowing the user 122 to finalize selection from amongst the one or more consensus selections.

In embodiments, the group matching and decision-making sub-module includes a consensus algorithm configured to determine the one or more consensus selections. The algorithm aggregates responses from the User Selection Module to generate a consensus score for each candidate option as a normalized function of per-user weights. For example, approval may be assigned a full weight (e.g., 1.0), indifference may be assigned a partial weight greater than zero and less than full approval, and disapproval a zero weight; candidate options with scores exceeding a threshold are added to a consensus list. The particular weights and threshold values are tunable to suit differing group dynamics and are not limited to these examples.

In alternative embodiments, the consensus algorithm includes one or more of instant-runoff voting, tiered elimination rounds, or simple majority voting, to determine the consensus list.

According to aspects of the present disclosure, the Backend Computing System 102, for example, via the Storage module 144, provides storage functionalities for the Backend Computing System 102 which is then utilized to provide one or more recommendations to the user 122 through application 124. In embodiments, Storage Module 144 includes at least a Database Management sub-module configured to store all, or a subset, interactions/activities of the user 122 with respect to application 124 running on user device 122, and/or all, or a subset, of data created by the Backend Computing System 102. In embodiments, stored data includes, but is not limited to: user profile data, user interactions, candidate data, group interactions, etc.

In an exemplary embodiment, a restaurant integration sub-module is included in the Storage module 144, and is configured to retrieve up-to-date, or real-time, data about one or more restaurants. In embodiments, the restaurant integration sub-module receives one or more restaurant recommendations, or restaurant selections, from one or more sources, such as the user 122, application 124, Recommendation Engine 142, and retrieves data about the one or more restaurants from a database, either internal or external to Backend Computing System 102, and returns the data for display to the user 122, or for other usage. In embodiments, the data includes, but is not limited to: one or more menus, one or more ratings, hours of operation, one or more reviews, a location, etc. It is understood that data retrieval, using Storage module 144, and/or Backend Computing System 102 can use various external sources-Google Places, Yelp Fusion, Foursquare, or proprietary databases, and can leverage offline caching. Additionally, functionality of Storage module 144 and/or database 114 can be implemented with different database technologies (SQL, NoSQL) and scalable infrastructures (monolithic servers, microservices, or serverless architectures).

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the Backend Computing System 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. The memory device 108 can also include one or more databases 114 that store information and data associated with the process and methods described below in further detail. While FIG. 1 illustrates a single memory device 108, the Backend Computing System 102 can include multiple memory devices 108, whether the same type or different types.

The communication device 106 enables the Backend Computing System 102 to communicate with other devices and systems. The communication device 106 can include, for example, a networking chip, one or more antennas, and/or one or more communication ports. The communication device 106 can generate radio frequency (RF) signals and transmit the RF signals via one or more of the antennas. The communication device 104 can generate electronic signals and transmit the RF signals via one or more of the communication ports. The communication device 106 can receive the RF signals from one or more of the communication ports. The electronic signals can be transmitted to and/or from a communication hardline by the communication ports. The communication device 106 can generate optical signals and transmit the optical signals to one or more of the communication ports. The communication device 106 can receive the optical signals and/or can generate one or more digital signals based on the optical signals. The optical signals can be transmitted to and/or received from a communication hardline by the communication port, and/or the optical signals can be transmitted and/or received across open space by the communication device 106.

The communication device 106 can include hardware and/or software for generating and communicating signals over a direct and/or indirect network communication link. As used herein, a direct link can include a link between two devices where information is communicated from one device to the other without passing through an intermediary. For example, the direct link can include a Bluetooth^{TM} connection, a Zigbee connection, a Wi-Fi Direct^{TM} connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a Wi-Fi connection where data is passed through a Wi-Fi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The Backend Computing System 102 can communicate with one or more network resources via the network 116. The one or more network resources can include external databases, social media platforms, search engines, file servers, web servers, or any type of computerized resource that can communicate with the Backend Computing System 102 via the network 116.

As described above, the Backend Computing System 102 can include hardware components to perform the processes described herein. In embodiments, one or more of components, hardware, and/or functionality of the Backend Computing System 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the Backend Computing System 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the ForkYes Environment 100, including the Backend Computing System 102 and/or the user device 120 can provide I/O devices for outputting information in a format perceptible by a user and receiving input from the user. For example, the Backend Computing System 102 can communicate with the I/O devices via the I/O interface 110. The I/O devices can display graphical user interfaces (“GUIs”) generated by the Backend Computing System 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

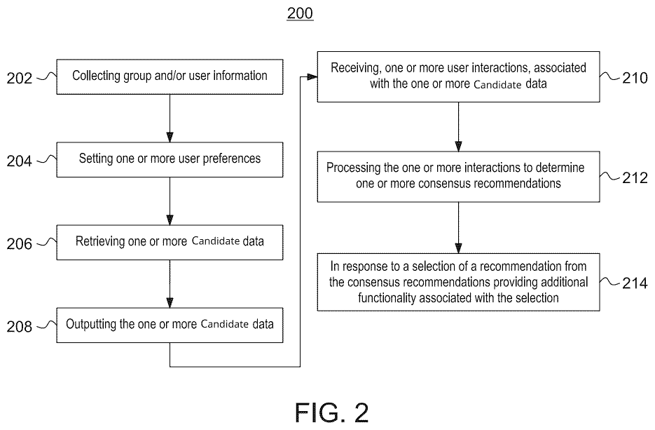

FIG. 2 illustrates a method 200 for consensus-based selection of candidate options using swipe-based interactions, according to aspects of the present disclosure. While FIG. 2 illustrates various stages of the method 200, additional stages can be added, and existing stages can be removed and/or reordered. This method 200 is designed to facilitate group decision-making by leveraging individual user preferences and interactions to suggest optimal options, which includes collecting group and user information 202, setting user or group preferences 204, fetching user or group candidate data 206, displaying, on a user interface, the user or group candidate data 208, filtering the user or group candidate data 210, processing the user or group candidate data to suggest a consensus match 212, and displaying, on the user interface, the suggested consensus match 214.

The method 200 begins with collecting group and user information 202. This step involves gathering data about the user 122, such as their dining preferences, past dining history, and any relevant group dynamics that might influence restaurant selection. This information forms the foundation for personalized recommendations. In embodiments, user information can be collected as one or more user profiles. Additionally, one or more groups can be created by inviting, or otherwise, aggregating one or more users, via their user profile, using a link, QR code, or other social media invitation.

In an exemplary embodiment, a session created by the user 122 is joined by one or more additional users. In embodiments, a link, or unique identifier, such as a QR code, is generated, and provided to the additional users who can join the session using said link. In embodiments, the user 122 provides one or more grouping criteria, such as, but not limited to, one or more time(s), one or more date(s), and/or one or more location(s), and in response one or more additional users matching the one or more grouping criteria are recommended to be paired, and/or paired with the user. In embodiments, one or more of application 124 and/or Backend Computing System 102 provides the matching of the one or more additional users.

In response to joining the session, the user, and/or the one or more additional users provide one or more user information items at step 204, such as preferences related to cuisine, budget, dietary restrictions, locations, etc. In embodiments, the one or more user information items are provided by User Profile Module of application 124, but is not so limited, as the user can provide the one or more information items in real-time, and/or the one or more information can be retrieve from a user profile, or data store, such as database 114. By setting these preferences 204, the system can tailor recommendations to better suit the group's collective needs.

Once preferences are set for a user, or group of users, one or more restaurant recommendations are fetched. In embodiments, one or more data items collected in steps 202-204 are utilized to form one or more queries, or requests, to one or more databases, internal, or external, to retrieve one or more restaurants having attributes matching the one or more data items. In embodiments, the retrieved one or more restaurants includes one or more data, or metadata, items associated therewith. In embodiments, the one or more data, or metadata items, include but are not limited to restaurant name, restaurant web page, a URL, a restaurant menu, restaurant ratings, location details, drink specials, events, dress code, busy/peak hours, dining location options (inside, outside, rooftop, patio, etc.), dog friendliness, child friendliness, photos or images, and other pertinent information that can aid in the decision-making process. In embodiments, the one or more data, or metadata, items, are provided by the Backend Computing System 102, internally, or are fetched externally by one or more APIs. In embodiments, recommendations are fetched, filtered, or otherwise processed, by Recommendation Engine 142 and/or Storage Module 144.

Once the candidate data is fetched 206, the one or more restaurant recommendations are displayed on a user interface 208. In embodiments, the one or more restaurant recommendations, along with the one or more data, or metadata items associated therewith are displayed to user 122, and/or the additional users, on application 124, operating on user device 120. In embodiments, each of the one or more restaurant recommendations along with the one or more data items associated therewith are grouped into individual user interface widgets for interaction with user 122, and the additional users. In an exemplary embodiment, each of the one or more restaurant recommendations are displayed as an interactive card user interface element and include the one or more data items associated therewith. The user interface presents the restaurant options in a manner that is easy to navigate and understand, allowing users to engage with the data effectively. In embodiments, candidate data can include any known data about a restaurant such as a name, one or more reviews, menus, prices, etc., and this information can be accessed by tapping on the user interface. In embodiments, display can be performed by one or more modules of application 124 on user device 120.

In response to displaying the one or more restaurant recommendations along with the one or more data items associated therewith on individual user interface widgets, the user 122, and/or the additional users, perform one or more interactions with the user interface widgets at 210. In embodiments, the one or more interactions include, but are not limited to a left swipe on one or more of the user interface widget, a right swipe on the one or more user interface widget, an upward swipe on the one or more user interface widget, a downward swipe on the one or more user interface widget, one or more multi-modal inputs, one or more voice commands, one or more inputs from an I/O device, and/or one or more tactile interactions with the one or more user interface widgets. The User Selection module of application 124 captures the one or more interactions. In an exemplary embodiment, each user can swipe, as an interaction, to the right to indicate approval and store a recommendation, upward or downward to indicate indifference and store a recommendation, and to the left to indicate disapproval and to discard the recommendation. In embodiments, the one or more interactions are utilized, along with the previously set preferences 204, to filter, in real-time, the one or more recommendations. In an exemplary embodiment, recommendations receiving disapproval are immediately removed from the results, while recommendations receiving approval/indifference remain for further review. The filtering process ensures that only the most relevant and suitable dining options are presented to the users, reducing decision fatigue and enhancing the overall user experience.

At step 212, one or more consensus suggestions or recommendations is determined. In embodiments, consensus is determined using a consensus algorithm. In embodiments, the consensus algorithm is the consensus algorithm of the group matching and decision-making sub-module of Recommendation Engine 142. This step utilizes the filtered data 210 to generate a recommendation that aligns with the group's preferences 204 and consensus. The suggestion is based on a combination of user interactions, preferences, and any group dynamics identified in the initial data collection phase 202. In embodiments, a restaurant match can be provided based on aggregated interactions, such as swipes, where an unanimously approved restaurant is presented as a first option, and in the case of non-unanimity, the most approved restaurants can be provided as a ranked list for users to select from.

At step 214, a recommendation can be selected from the one or more consensus suggestions or recommendations, and in response to the selection one or more additional functionalities are provided. In embodiments, a first functionality includes displaying the selection, on user device 120, to user 122. In embodiments, the restaurant integration module retrieves data for the selection, as described above, and provides the data to the user interface of user device 120, through application 124, for display and interaction by user 124. In embodiments, a second functionality includes integrated reservation booking. In embodiments, in response to the selection the user provides one or more reservation data items, such as a time, number of diners, etc., and a reservation booking is automatically completed. In embodiments, reservation booking is performed by the Integration module, as described above. In embodiments, a third functionality includes post-dining functionality including rating and review. In embodiments, once dining is completed the user 122 provides at least one of a rating, and/or review about the dining experience. In embodiments, the at least one rating is a numerical rating from 1-5 (1 being the lowest rating and 5 being the highest rating), but can also utilize one or more icons, such as stars. Additionally, the review is a short textual review having one to two sentences. In embodiments, the rating and/or review is provided for use by the Backend Computing System 102, such as the one or more Machine Learning Models of Recommendation Engine 142, to further refine future recommendations.

This step presents the recommended dining option to the users, allowing them to review the suggestion and make a concluding decision. The display includes detailed information about the restaurant, such as the menu, location, and user reviews, to assist users in their decision-making process.

While the present invention is described primarily in the context of restaurant discovery and group decision-making, the inventive concept of a real-time, swipe-based group consensus system is also applicable beyond restaurant selection. Alternative embodiments may leverage this intuitive, swipe-driven interaction method for various other group decisions, such as choosing entertainment options (movies, concerts, activities), planning group events or travel itineraries, collaboratively selecting products or services, or making collective decisions within professional or social settings. The flexibility and intuitive nature of the swipe-based consensus mechanism uniquely facilitate rapid and accurate decisions in diverse contexts, further highlighting the non-obviousness and broad applicability of the present invention.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A computer-implemented method for group consensus decision-making, comprising:
receiving, by one or more processors, user interactions from a plurality of users within a group session, the user interactions comprising gesture-based or equivalent inputs applied to candidate options identified by candidate identifiers within a common candidate set for the group session;
aggregating, by the one or more processors, the user interactions using a consensus process that distinguishes approval, disapproval, and indifference;
determining, by the one or more processors, one or more consensus selections from the common candidate set based on results of the aggregating; and
in response to selection of at least one consensus selection, automatically initiating at least one post-selection action associated with the at least one consensus selection.

2. The method of claim 1, wherein the group session is created by receiving, from a first user, an identification of group members and transmitting invitations via at least one of a URL, a QR code, or a social-media message.

3. The method of claim 1, wherein the one or more processors receive grouping criteria from a first user and automatically identify additional users based on the grouping criteria.

4. The method of claim 1, wherein the gesture-based or equivalent inputs comprise at least one of a right swipe indicating approval, a left swipe indicating disapproval, an upward swipe indicating indifference, a tap or touch input, or a voice command.

5. The method of claim 1, further comprising updating the common candidate set during the group session by removing options that receive disapproval and retaining options that receive approval or indifference.

6. The method of claim 1, wherein determining the one or more consensus selections comprises applying a quorum rule that requires at least a threshold number or percentage of approvals for a candidate option.

7. The method of claim 1, further comprising, upon failure to meet the quorum rule, executing a tie-break process selected from an instant-runoff process or a tiered elimination process to identify the one or more consensus selections.

8. The method of claim 1, wherein the consensus algorithm assigns a full weight value to approvals, a non-zero partial weight value to indications of indifference, and a zero weight value to disapprovals, and identifies the one or more consensus selections by comparing aggregated scores to a threshold.

9. The method of claim 1, wherein determining the one or more consensus selections is performed by a server that aggregates user interactions received from multiple user devices without transmitting the full common candidate set to each user device.

10. The method of claim 1, wherein the post-selection action comprises at least one of:
generating a reservation, booking, or scheduling entry; outputting the consensus selection to the group; initiating purchase or ticketing; or presenting a rating, review, or feedback interface.

11. The method of claim 1, wherein client transmissions comprise interaction messages that include a session identifier and a candidate identifier but exclude candidate metadata larger than a predefined size threshold.

12. The method of claim 1, wherein the candidate options comprise at least one of:
restaurants, bars, cafes, entertainment venues, events, travel accommodations, media items, or workplace options.

13. The method of claim 1, further comprising maintaining, for each user, a profile storing preferences and past interactions, and using the profiles to select or order the common candidate set for the group session.

14. The method of claim 1, wherein determining the one or more consensus selections comprises generating a ranked list of candidate options for presentation to the group.

15. A system for group consensus decision-making, comprising:
a communication interface configured to exchange data with a plurality of user devices;
one or more memory devices storing user profiles, candidate option data, and a session record comprising a session identifier, a list of candidate identifiers, and an interaction log keyed by user and candidate identifiers; and
one or more processors operatively coupled to the communication interface and the one or more memory devices, the one or more processors configured to:
create and manage a group session defining a common candidate set for the plurality of user devices;
receive user interactions with the common candidate set from the plurality of user devices, the interactions comprising gesture-based or equivalent inputs;
aggregate the user interactions using a consensus algorithm that distinguishes approval, disapproval, and indifference;
determine one or more consensus selections from the common candidate set; and
in response to selection of at least one consensus selection, automatically initiate at least one post-selection action associated with the at least one consensus selection.

16. The system of claim 15, wherein the one or more processors are further configured to apply a quorum rule to approve a candidate option and, upon failure to meet the quorum rule, to execute an instant-runoff or tiered elimination process.

17. The system of claim 15, wherein the one or more processors compute the one or more consensus selections server-side using interactions aggregated across the plurality of user devices without transmitting the full common candidate set to each user device.

18. The system of claim 15, wherein the post-selection action comprises integration with at least one external service selected from reservation platforms, event ticketing systems, calendar tools, or social-media applications.

19. The system of claim 15, wherein the consensus algorithm assigns a full weight value to approvals, a non-zero partial weight value to indications of indifference, and a zero weight value to disapprovals, and identifies the one or more consensus selections by comparing aggregated scores to a threshold.

20. A non-transitory computer-readable storage medium storing instructions that, when executed by one or more processors, cause the one or more processors to perform the method of claim 1.
